(19) United States
(12) Patent Application Publication
(10) Pub. No.: US 2020/0389523 A1
(43) Pub. Date: Dec. 10, 2020

(54) SYSTEM AND METHOD FOR REAL TIME ACTUATION IN LOW POWER WIDE AREA NETWORK INTERNET OF THINGS NETWORKS

(71) Applicant: MOTOROLA SOLUTIONS, INC., Chicago, IL (US)

(72) Inventors: JACOB SHEM TOV, JERUSALEM (IL); GONEN PELEG DAHAN, BUFFALO GROVE, IL (US); IDO MERKADO, TEL AVIV-YAFFO (IL)

(21) Appl. No.: 16/431,823

(22) Filed: Jun. 5, 2019

(51) Int. Cl. H04L 29/08; H04L 12/28; H04W 4/10

(52) U.S. Cl. CPC H04L 67/12; H04W 4/10; H04L 12/2854

(57) ABSTRACT

Techniques for real time actuation in low power wide area network internet of things networks are provided. In one aspect, an internet of thing (IoT) node including a local event sensing circuit and operating in a low power mode, may receive an indication of a local event. The indication of the local event may be sent to a control center, wherein the control center may validate that the local event corresponds to an in-progress incident. An indication may be received from the control center to switch the IoT node from a low power mode to a high power mode when the local event corresponds to an in-progress incident. The IoT node may switch to the high power mode, wherein the high power mode allows for real time communication with the IoT node.

### BACKGROUND

The advent of inexpensive, low power, wireless networking circuitry has made it economically feasible to connect almost any device to a network, such as the Internet. The range of devices that can be connected are virtually unlimited. In some cases, those devices may be operated by human users and may include devices such as laptops, smartphones, tablet computers, and the like. These types of devices may allow a human user access to a network, such as the Internet.

The Internet of Things (IoT) generally includes devices that may not necessarily be associated with a particular user. For example, devices such as sensors and actuators may be wirelessly connected to allow those sensors to be read or the actuators to be activated remotely. For example, in a public safety context, a fire hydrant may be equipped with a sensor to detect water pressure. The sensor may wirelessly connect to an IoT network in order to allow the pressure to be read remotely (e.g. from a command center). As yet another public safety example, a building may be equipped with smart locks which may be connected to an IoT network. A properly authorized law enforcement officer may connect to the smart lock over the IoT network in order to actuate the lock (e.g. cause it to unlock) in an emergency situation.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an example environment that may implement the system that may implement the real time actuation in low power wide area networks (LPWAN) IoT networks techniques described herein.

FIG. 2 is an example of a flow diagram for implementing the real time actuation in LPWAN IoT networks techniques described herein.

FIG. 3 is an example of a device that may implement the real time actuation in LPWAN IoT networks techniques described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In IoT networks, the devices (e.g. sensors, actuators, etc.) are often powered by batteries, which means that the devices are only capable of operation when connected to a charged battery. This causes tensions between two opposing desired traits of IoT devices. On one hand, it is desirable for an IoT device to be constantly wirelessly connected to the network, such that the device can send/be queried for data or receive instructions to actuate at any time. The always on functionality comes at the price of higher battery usage, as the wireless connection requires power to function. On the other hand, it is desirable for IoT devices to be able to operate for long periods of time without maintenance (e.g. battery replacement). Such operation suggests that the IoT device should remain disconnected from the wireless network, unless the device has data to transmit. The downside of this mode of operation is that the device cannot be communicated with at arbitrary times, but rather communications can only occur when the device has connected to the IoT network.

One popular protocol for IoT is Long Range WAN (LoRaWAN). The LoRaWAN protocol defines three classes of IoT devices. IoT devices may also be referred to as IoT nodes. Class A nodes do not connect to the network (e.g. wireless transmitter remains off—thus conserving power) unless the node itself determines there is a need to transmit information. At that point, the Class A node connects to the network, transmits the data, then remains connected for a relatively short, finite period of time, during which communications from the network (e.g. commands, instructions, parameters, etc.) may be received. Once this receive window has closed, the node disconnects from the wireless network until the next time the node has data to send. As should be clear, the network has no ability to initiate communication with the Class A node until the node first decides to connect to the network.

Class B nodes operate similarly to Class A nodes, in that they save power by not maintaining a continuous connection to the network. Instead, the Class B node may periodically, and on a defined schedule, wake up and connect to the network for a finite period of time. During this period of time, the node may send data to the network (if it has any to send) as well as receive communications (e.g. commands, instructions, parameters, etc.) from the network. The network is aware of the wake up schedule, and knows when the Class B node will be awake and able to receive communications. Thus the network does not need to rely on the node itself being the first to initiate communication. Unfortunately, this comes at a cost of requiring the node to use power to periodically connect to the network, regardless of if there is information to send or not. Thus, Class B nodes may require more maintenance compared with Class A nodes, to ensure that the batteries are charged.

Class C nodes remain connected to the network at all times. Although this provides the advantage of allowing communication with the Class C node at any time, the price paid is that the node is constantly using power to maintain the wireless connection. Thus, there may be an increase in maintenance of Class C nodes, as the batteries may need to be replaced more often than in Class B nodes.

A problem arises in that in some applications, the lowest power consumption possible may be desired to maximize the period between changing the batteries in the node. For example, consider the public safety case where an IoT device is a smart door lock that can be remotely actuated by law enforcement during an incident. During the vast majority of time, there will be no incident occurring, and the smart door lock would have no reason to use battery power to connect to the network to receive a command from a law enforcement officer to actuate. Class A operation may not be appropriate, as there may never be an event that occurs at the smart door lock that would cause the node to initiate communication with the network. Thus, the law enforcement officer may never have the opportunity to issue a command to cause the door to unlock because the node itself may never connect to the network.

Class B operation may also not be appropriate. As mentioned above, Class B operation requires the node to periodically connect to the network, during which time it can receive commands. The length of the period between connections to the network may render this mode of operation unsuitable. For example, if the period of operation is to connect once every three hours, it is possible that a law enforcement officer may be required to wait as long as three hours before being able to issue a command to cause the door to unlock. Shortening the period would reduce the time interval between periods of connection to the network, but comes at the expense of additional battery usage. Shortening the period to zero effectively would turn the node into a Class C node, thus eliminating the wait time for the law enforcement officer. However, Class C operation would effectively cause the wireless transmitter to remain on constantly, which would lead to even greater battery consumption.

The techniques described herein overcome these problems and others by including a local event sensing low power circuit on the IoT node. The IoT node may normally operate in the Class A mode. The event sensing circuit in some cases may be relatively unrelated to the main purpose of the node. For example, in the smart door lock example provided above, the event sensing circuit may be an audio transducer configured to detect the sound of a law enforcement officer's vehicle siren. Upon activation of the event sensing circuit, the node may connect to the IoT network and communicate that the local event sensing circuit has been activated.

The communication may be received by a central authority within the system (e.g. a command center) that would be able to verify if the event sensing circuit was properly triggered. For example, when the smart door lock senses the vehicle siren, this can be communicated to a law enforcement incident tracking system. The system may then determine if there is an active incident at the location including the smart door lock (e.g. the siren was likely that of a law enforcement officer responding to the incident) or if there is no incident at the location (e.g. the siren was simply a law enforcement vehicle driving past the location of the smart door lock).

If it is determined that the activation of the local event sensing circuit was proper, the node may be commanded to switch into Class C operation. In class C operation, the node remains constantly connected to the IoT network and ready to receive commands. As noted above, when a Class A node connects to the network, it listens for commands for a short, finite period of time. It is during this period of time that the command to switch to Class C may be sent.

In the case of the smart door lock, the law enforcement agent may, using his handheld radio, issue commands to lock/unlock the door. Because the node would be operating in Class C mode, it would be able to respond without any delay.

In addition, the node with the event sensing circuit may be coupled to other nodes and may trigger those other nodes to change to class C operation as well. For example, consider a large apartment complex with smart locks on all interior and exterior doors. A siren sensing circuit may be included on the exterior door nodes, and those exterior door nodes may be coupled to the interior door nodes (e.g. via wire, low power Bluetooth, etc.). When the event sensing circuit on an exterior door is activated and the incident confirmed, the exterior door node may indicate to all the interior door nodes that they should switch to class C operation and be prepared to receive commands from a law enforcement officer at any time.

Once the incident has finished (e.g. the incident is indicated as cleared in the incident management system) all of the nodes may be commanded to return to class A mode, thus returning to battery power preserving mode.

A method is provided. The method includes receiving, at an Internet of Things (IoT) node operating in a low power mode, the IoT node including a local event sensing circuit, an indication of a local event. The method further includes sending the indication of the local event to a control center, wherein the control center validates the local event corresponds to an in-progress incident. The method also includes receiving an indication from the control center to switch the IoT node to a high power mode when the local event corresponds to an in-progress incident. The method also includes switching to the IoT node to the high power mode, wherein the high power mode allows for real time communications to the IoT node.

In one aspect, the method further includes remaining in the low power mode when the local event does not correspond to an in-progress incident. In one aspect, the method further includes receiving an indication that the in-progress incident has completed and switching the IoT node to the low power mode. In one aspect the indication that the in-progress incident has completed is received from the local event sensing circuit. In another aspect, the indication that the in-progress incident has completed is received from the control center.

In one aspect, the method further includes propagating the indication of the local event to other IoT nodes communicatively coupled to the IoT node, wherein the other IoT nodes switch to the high power mode upon receipt of the propagated indication of the local event. In one aspect, the low power mode is a Long Range Wide Area Network (LoRaWAN) class A mode and the high power mode is a LoRaWAN class C mode.

In one aspect, the method further includes actuating the IoT node using a node actuation circuitry via real time communications to the IoT node. In one aspect, the method further includes actuating the IoT node via a Push-to-Talk (PTT) interface via the real time communications to the IoT node. In one aspect, the local event sensing circuitry and the node actuation circuitry are the same circuitry.

A system is provided. The system includes a processor and a memory coupled to the processor, the memory containing thereon a set of instructions that when executed by the processor cause the processor to receive, at an Internet of Things (IoT) node operating in a low power mode, the IoT node including a local event sensing circuit, an indication of a local event. The instructions further cause the processor to send the indication of the local event to a control center, wherein the control center validates the local event corresponds to an in-progress incident. The instructions further cause the processor to receive an indication from the control center to switch the IoT node to a high power mode when the local event corresponds to an in-progress incident. The instructions further cause the processor to switch to the IoT node to the high power mode, wherein the high power mode allows for real time communications to the IoT node.

In one aspect, the instructions further cause the processor to remain in the low power mode when the local event does not correspond to an in-progress incident. In one aspect, the instructions further cause the processor to receive an indication that the in-progress incident has completed and switch the IoT node to the low power mode. In one aspect, the instructions further cause the processor to propagate the indication of the local event to other IoT nodes communicatively coupled to the IoT node, wherein the other IoT nodes switch to the high power mode upon receipt of the propagated indication.

In one aspect, the instructions further cause the processor to actuate the IoT node using a node actuation circuitry via real time communications to the IoT node. In one aspect, the instructions further cause the processor to actuate the IoT node via a Push-to-Talk (PTT) interface via the real time communications to the IoT node.

A non-transitory processor readable medium containing a set of instructions thereon is provided. When executed by a processor the instructions cause the processor to receive, at an Internet of Things (IoT) node operating in a low power mode, the IoT node including a local event sensing circuit, an indication of a local event. The instructions further cause the processor to send the indication of the local event to a control center, wherein the control center validates the local event corresponds to an in-progress incident. The instructions further cause the processor to receive an indication from the control center to switch the IoT node to a high power mode when the local event corresponds to an in-progress incident. The instructions further cause the processor to switch to the IoT node to the high power mode, wherein the high power mode allows for real time communications to the IoT node.

In one aspect, the instructions further cause the processor to receive an indication that the in-progress incident has completed and switch the IoT node to the low power mode. In one aspect, the instructions further cause the processor to actuate the IoT node using a node actuation circuitry via real time communications to the IoT node. In one aspect, the instructions further cause the processor to actuate the IoT node via a Push-to-Talk (PTT) interface via the real time communications to the IoT node.

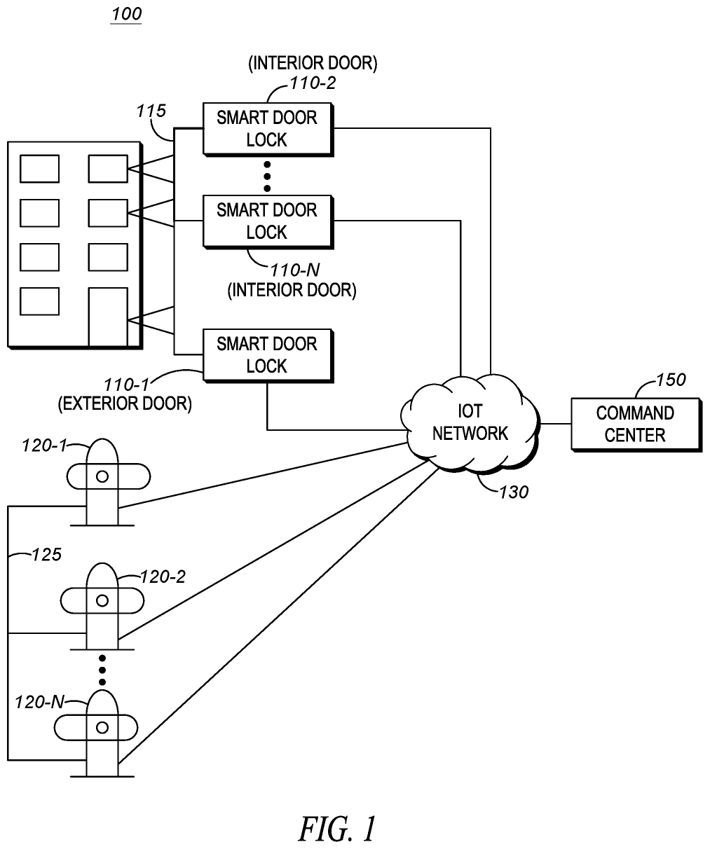

FIG. 1 is an example environment that may implement the system that may implement the real time actuation in low power wide area networks (LPWAN) IoT networks techniques described herein. Environment 100 may include a plurality of IoT nodes 110-1 . . . n and 120-1 . . . n, an IoT network 130, and a command center 150. The example environment shown in FIG. 1 is described in terms of two example IoT devices. IoT nodes 110-1 . . . n may be a device, such as a smart door lock. IoT nodes 120-1 . . . n may be a device such as an IoT equipped fire hydrant. Although two specific examples of types of IoT nodes are described, it should be understood that this is for purposes of ease of description. The techniques described herein are not limited to these examples, and would be applicable in any environment including IoT nodes that can switch between low/high power operation based on triggering of a local event sensing circuit.

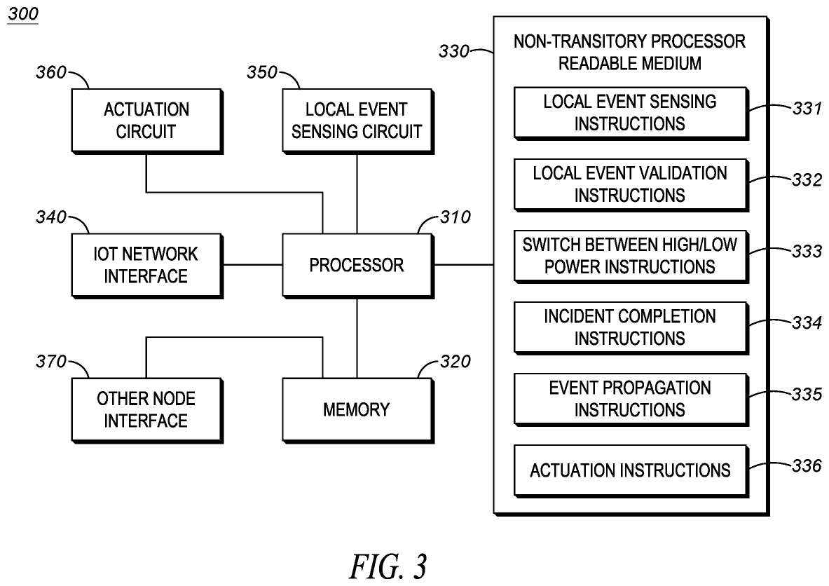

An example IoT node 110-1 may be a smart door lock. The smart door lock may be a device similar to the one described in FIG. 3. The smart door lock may include a IoT network interface to allow the device to connect to IoT network 130. The IoT network interface may be a wireless interface that may operate in a low or high power mode. In the low power mode, the IoT network interface may not connect to the IoT network unless the node has data to send to the IoT network. For example, in the case where the IoT network is a LoRaWAN network, the low power mode may be a node operating as a Class A node. In the high power mode, the IoT network interface may remain connected to the IoT network at all times. In the case of a LoRaWAN network, the high power mode may be a node operating as a Class C node.

The smart door lock may include an actuation circuit that allows the device to cause a door to lock or unlock. In other words, the smart door lock may be able to receive commands from the IoT network to cause a door associated with the node to lock or unlock. The node may also include a local event sensing circuit to sense local events. For example, in one implementation, the local event sensing circuit may be a siren sensor that may trigger when the local event sensing circuit detects the sound of a law enforcement vehicle siren.

In operation, node 110-1 may normally run in the low power (e.g. Class A mode), thus preserving battery by not wirelessly connecting to the IoT network 130. At some point, the local event sensing circuit may be triggered upon detection of a law enforcement vehicle siren. Upon triggering, the node 110-1 may connect to the IoT network and send an indication of the triggering of the local event sensing circuit to a command center 150 to determine if the trigger is associated with an incident occurring at the node's location.

For example, consider an apartment building whose front door includes node 110-1. The local event sensing circuit may be triggered by a police vehicle responding to a call for service at the apartment building. Alternatively, the local event sensing circuit may be triggered by a police vehicle passing by the apartment building location while on its way to a different location. The node may send an inquiry to the command center 150 to determine if there is currently an incident in progress at the node's location. If not, this may be considered a false trigger, and the node may disconnect from the network and continue to operate in the low power mode.

On the other hand, if the command center 150 indicates that there is an incident occurring at the node's location, the node may switch to high power (e.g. Class C) operation, during which time the node remains connected to the IoT network 130. In some implementations the node may perform the switch to high power autonomously upon validation of an in-progress incident, while in other cases, the node may receive a command (e.g. from the command center) to switch to high power operation. What should be understood is that the node switches to high power mode such that it remains connected to the IoT network and can receive commands at any time.

For example, in an example implementation, a law enforcement officer may use his handheld radio to issue commands to IoT node 110-1 via IoT network 130 to cause the door to unlock, such that the officer may gain access to the building. It should be noted that the smart door lock would only remain connected to the IoT network if it has been confirmed by the command center that there is an in-progress incident, thus ensuring the officer has at least some basis for requesting the door to be unlocked. If there was no in-progress incident, the smart door lock would not be connected to the IoT network and as such would not be able to respond to a command to unlock the door.

Node 110-1 may also be equipped with an interface to communicate with other nodes. For example, continuing with the example of a smart door lock on an apartment building, the exterior doors may be equipped with a siren local event sensing circuit, because they are likely to be able to detect the presence of a siren as they are located on the building exterior. Interior doors, even though equipped with the same siren event sensing circuit, may never be triggered as they may never detect the presence of a siren due to not being located near the exterior of the building.

Node 110-1 may be coupled to nodes 110-2 . . . n through a local node interface 115. Such an interface may be a wired interface (which may be feasible since all the doors in a building are located relatively close to each other) or a low powered wireless interface (e.g. Bluetooth Low Energy, etc.) Upon detection of a siren and confirmation of an in-progress incident, node 110-1 may use the local node interface to propagate the local event to the other nodes 110-2 . . . n, which may then cause those nodes to behave just as if their own local event sensing circuits had been triggered (e.g. connect to IoT network 130, verify incident, switch to high power mode, etc.).

Once the incident has completed, the command center 150 may send an indication to the nodes 110-1 . . . n that the in-progress incident has completed. Each of those nodes may then switch back to low power mode (e.g. Class A mode) in order to preserve battery.

Nodes 120-1 . . . n are another example of an IoT node that may utilize the techniques described herein. For example, nodes 120-1 may be fire hydrants that has a local event sensing circuit that maybe utilized to detect when a fire hose is connected. Once a hose is connected, the node may connect to the IoT network 130 in order to query the command center 150 to determine if there is an in-progress incident in the area. If so, the node may switch to high power mode. Node 120-1 may be equipped with an actuation circuit in the form of a water pressure sensor. Once switched to the high power mode, the node may send water pressure measurements to the IoT network. Just as above, node 120-1 may also be coupled to other nearby nodes 120-2 . . . n via wired or low power wireless connection 125. Node 120-1 may propagate the hose connection local event to the other nodes 120-2 . . . n to cause them to behave just as if a hose had been directly connected to those other nodes.

It should be noted that the event sensing circuit and the actuation circuit need not be separate circuits, and in fact may be the same circuit. For example, in the fire hydrant example, the pressure sensor circuit may be the local event sensing circuit. A drop in water pressure may indicate that a hose has been connected and turned on, thus causing a drop in water pressure. This trigger may cause the fire hydrant to connect to the command center to determine if there is an in-progress incident. If so, operation can proceed as above, with the node remaining connected to the IoT network and continuing to provide water pressure measurements. If there is no in-progress incident, this may indicate another condition (e.g. a leak) which may then be addressed by the command center.

Although IoT nodes utilizing the techniques described herein have been described in terms of public safety use cases (e.g. siren detection, fire hydrants) it should be understood that the techniques are not so limited. The techniques may be utilized in any situation where a local event may trigger a node operating in a low power mode to connect to an IoT network, verify the validity of the local event, and then switch to a high power mode until the in-progress incident has been indicated as completed.

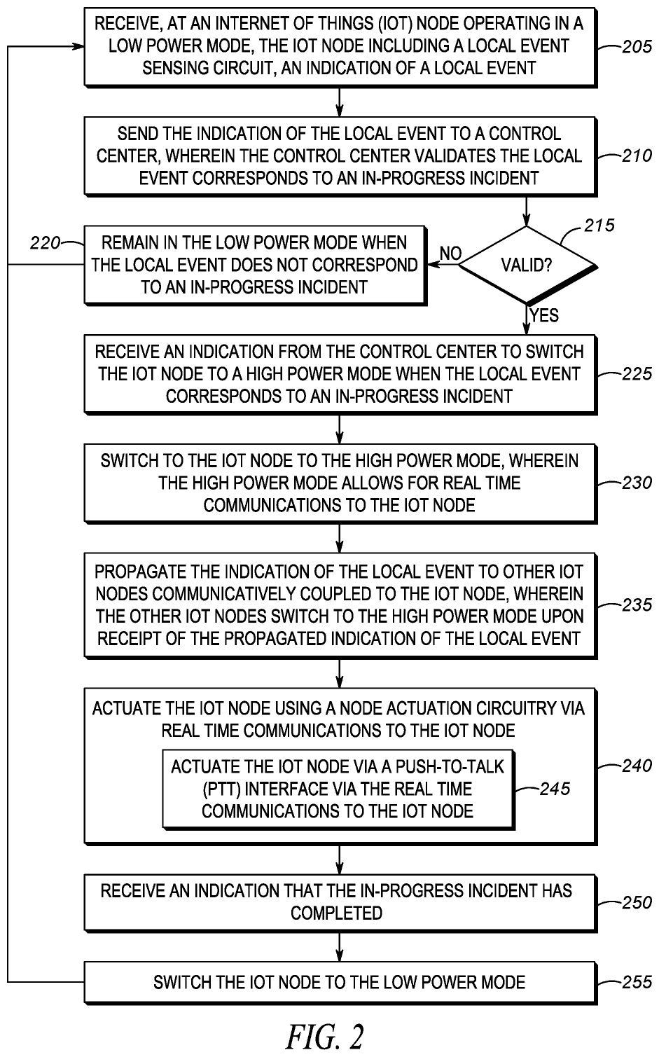

FIG. 2 is an example of a flow diagram for implementing the real time actuation in LPWAN IoT networks techniques described herein. In block 205, an indication of a local event may be received at an IoT node operating in a low power mode, the IoT node including a local even sensing circuit. As described above, the low power mode may be a mode, such as LoRaWAN Class A, in which the IoT node does not maintain a connection to the network unless a triggering event cause the node to create a connection to the network. The local event sensing circuit may be a circuit, such as a low power circuit, that may be used to detect events that may or may not be directly related to the purpose of the IoT node.

For example, in the fire hydrant example use case, the IoT node may include a pressure sensor used to measure and report water pressure to a central location. The pressure sensor may also act as the local event sensing circuit. In other cases, the local event sensing circuit may be unrelated to the purpose of the IoT node. In the example of the smart door lock, the siren sensing circuit is not related to the nodes primary function, which is to actuate the door lock. It should be understood that in some cases the local event sensing circuitry and the node actuation circuitry are the same circuitry (e.g. fire hydrant pressure example) while in other cases, the circuitry may be different (e.g. door lock/siren detector example).

In block 210, the indication of the local event may be sent to a control center. The control center validates that the local even corresponds to an in-progress incident. In some cases, the event sensing circuit may be triggered by an invalid event. In the examples above, a door lock node may include a siren sensor. It is possible that a passing emergency vehicle caused the local event sensing circuit to trigger as opposed to a real incident. Likewise, in the case of a water pressure sensor, a temporary drop in pressure may not indicate an actual incident is in-progress.

In block 215, if the control center determines that the triggering of the local event sensing circuit was not valid, the process moves to block 220. In block 220, the IoT node may remain in the low power mode when the local event does not correspond to an in-progress incident. In other words, if the triggering of the local event sensing circuit was a false alarm, the IoT can continue to operate in a low power (e.g. Class A) mode, thus preserving battery life.

If it is determined in block 215 that the triggering of the local event sensing circuit was valid (i.e. there is an in-progress incident associated with the triggering) then the process moves to block 225. In block 225, an indication may be received from the control center to switch the IoT node to a high power mode when the local event corresponds to an in-progress incident. For example, in the case of a LoRaWAN node, the node may be commanded to begin operation in Class C mode. As described above, in the high power mode, the node may remain wirelessly connected to the network at all times. Thus, the node is able to respond to queries immediately as it remains connected to the network.

In block 230, the IoT node may switch to the high power mode (e.g. Class C mode) wherein the high power mode allows for real time communication to the IoT node. Real time communications means that the node is always listing for commands from the network, as opposed remaining disconnected (e.g. Class A mode) from the network or only periodically (e.g. Class B mode) connecting to the network. When operating in the high power mode, the node stays connected to the network and is able to receive messages from the network at any time. The node need not wait until it has data to send to the network or for a periodic wake up.

In some implementations, a node may propagate the indication of a local event to other nodes. In block 235, the indication of the local event may be propagated to other IoT nodes that are communicatively coupled to the IoT node. Upon receipt of the indication of the local event, the other IoT nodes may switch to the high power mode. In some implementations, propagation may occur by triggering the local event sensing circuit of the other nodes. For example, in the example, of a fire hydrant equipped with a hose attachment local event sensing circuit, the node that has a hose attached may propagate a signal to other hydrants (e.g. via a wireless or wired connection) to cause those other nodes to believe a hose has been attached. Those nodes may then operate just as if a hose had been attached, and would proceed just as if a hose had been directly attached (e.g. confirm valid incident, change to high power mode, etc.)

In other implementations, the signal may be propagated to other nodes to directly command them to transition to the high power mode. For example, in the case of the smart door locks where external doors include siren sensors and the internal door sensors do not include siren sensors, upon detection of a siren, the external doors may verify a valid incident is occurring. Upon confirmation, the external door sensors may propagate the indication by directly commanding the internal doors (e.g. via short range wireless or direct wired communication) to switch to high power mode. Thus, the internal nodes do not need to independently confirm the validity of the incident.

Regardless of how the indication is propagated, what should be understood is that other IoT nodes that did not have a local event sensing circuit directly triggered can still be caused to switch to the high power mode based on another node have its local event sensing circuit triggered.

In block 240, the IoT node may be actuated using node actuation circuitry via real time communication to the IoT node. As mentioned above, actuation of the node includes both sending of data from the IoT node to the network or receiving commands from the network to perform some action. For example, in the case of a fire hydrant with a water pressure sensing circuit, actuation of the node may include sending a water pressure measurement to the network. In the example, case of the smart door locks, actuation may include receiving a command to lock/unlock the door and causing an electro mechanical component coupled to the door locking mechanism to lock/unlock.

The techniques described herein are not limited to any particular type of actuation. Although examples of fire hydrants and smart door locks have been presented, the techniques are applicable to any type of IoT node that includes circuitry for any type of actuation. The actuation may be passive (e.g. taking measurements), active (e.g. causing a change of state of a physical element), or a combination of passive and active. What should be understood is that the techniques described herein are usable with any form of actuation.

In one particular implementation, the actuation of the node may be via a Push-to-Talk (PTT) interface. In block 245, the IoT node may be actuated via a PTT interface via the real time communications to the IoT node. As described above, public safety personnel may be equipped with communications devices such as Land Mobile Radio (LMR) or other devices providing similar functionality (e.g. Push-to-talk over Cellular (PoC)). Depressing a button on the device may cause initiating of a half duplex call session. Although those sessions are typically to other public safety users, they can also be used to communicate with IoT nodes.

For example, a police officer approaching a door with a smart lock as described above, press the PTT button on his LMR radio and say “unlock door number 110-1.” This command may be received over the LMR network and converted to an IoT command which may then be sent to the smart door lock over the IoT network. In another implementation, the public safety officer's device may directly connect to the IoT network as another IoT node. The officer may then use his device to send commands to the IoT node using the PTT interface. What should be understood is that once an IoT node has switched to the high power mode, it may be actuated by any device connected to the IoT network and authorized to actuate the IoT node.

In block 250, and indication may be received that the in-progress incidents has completed. As mentioned above, prior to switching to the high power mode, the IoT node may confirm that the triggering of the local event sensing circuit is actually associated with an in-progress incident. At some point in time, that incident may end. In some cases, the node itself may be able to determine that the incident has completed. For example, in the case of a fire hydrant with a hose connection event sensing circuit, the same circuit would be able to detect when the hose has been disconnected. Thus, the indication of the completion of the in-progress incident may be generated locally.

In other cases, the indication of the end of the in-progress incident may come over the IoT network because the IoT event sensing circuit may not be able to determine the end of the incident. In the example of the smart door lock with the siren sensor, the absence of the siren may not itself indicate the incident has ended. For example, a law enforcement officer may turn off his vehicle siren after arrival on scene. However, this may not indicate the incident is over, but may actually indicate the incident is just getting underway. In such cases, the command center may provide an indication to the IoT node once the in-progress incident is complete.

Regardless of the source of the indication that the in-progress incident has completed, at some point the indication is received by the IoT node. In block 255, the IoT node may be switched back to the low power (e.g. Class A) mode. The benefits of the low power mode (e.g. less battery consumption) may then be resumed.

FIG. 3 is an example of a device that may implement the real time actuation in LPWAN IoT networks techniques described herein. It should be understood that FIG. 3 represents one example implementation of a device that utilizes the techniques described herein. Although only a single processor is shown, it would be readily understood that a person of skill in the art would recognize that distributed implementations are also possible. For example, the various pieces of functionality described above (e.g. event sensing, node actuation, IoT network interface, etc.) could be implemented on multiple devices that are communicatively coupled. FIG. 3 is not intended to imply that all the functionality described above must implemented on a single processor.

Device 300 may include processor 310, memory 320, non-transitory processor readable medium 330, IoT network interface 340, local event sensing circuit 350, and actuation circuit 360.

Processor 310 may be coupled to memory 320. Memory 320 may store a set of instructions that when executed by processor 310 cause processor 310 to implement the techniques described herein. Processor 310 may cause memory 320 to load a set of processor executable instructions from non-transitory processor readable medium 330. Non-transitory processor readable medium 330 may contain a set of instructions thereon that when executed by processor 310 cause the processor to implement the various techniques described herein.

For example, medium 330 may include local event sensing instructions 331. Local event sensing instructions 331 may cause the processor to utilize local event sensing circuit 350 to detect the occurrence of local events. As explained above, the techniques described herein are not limited to any particular type of local event detection. For example, the local even detection may be a sensor that indicates the occurrence of an external event (e.g. siren detection) or of an event more closely associated with the node (e.g. a pressure sensor change). Local event sensing instructions generally correspond with blocks 205.

Medium 330 may also include local event validation instructions 332. Local event validation instructions may be used by processor 310 to determine if a locally sensed event is associated with an in-progress incident. As explained above, in some cases, it may be possible for a local event sensing circuit to be triggered when there is no incident in progress. Local event validation instructions may use IoT network interface to communicate with a command center to determine if the triggering of the local event sensing circuit is associated with an in-progress event. Local event sensing instructions generally correspond with blocks 210, 215, 220, and 225.

Medium 330 may also include switch between high/low power instructions 333. As described above, low power (e.g. LoRaWAN class A) may cause the device to conserve battery power by not utilizing IoT network Interface 340 to connect to the IoT network. In other words, by turning the IoT interface, which may be a wireless interface, switched off, may conserve power that would otherwise be used to maintain a connection when no data is being transferred. High power (e.g. LoRaWAN class C) may be used to allow the device to remain connected to the IoT network and be able to receive commands from/send data to the IoT network. The switch between high/low power instructions 333 may allow the device 300 to switch between these modes. Switch between high/low power instructions generally correspond with blocks 230 and 255.

Medium 330 may also include incident completion instructions 334. Using the incident completion instructions, device 300 may be able to determine when an incident has completed and the device can return to the low power mode. In some cases, the incident completion instructions may cause the device to utilize the local event sensing circuit 350 to determine if the local event that caused the device to switch to the high power mode still exists. In other cases, the incident completion instructions may cause the device to utilize the IoT network interface 340 to communicate with a command center to determine if the incident is complete. Incident completion instructions generally correspond with block 250.

Medium 330 may also include event propagation instructions 335. The event propagation instructions may cause the device 300 to utilize other node interface 370 to notify other IoT nodes that a local event has been detected by the event sensing circuit of the IoT node. When the other nodes receive the indication, they may respond just as they would if a local event had occurred at the other IoT nodes. In other words, the nodes would behave as if their own local event sensing circuit was triggered. Likewise, when an in-progress incident has completed, the event propagation instructions can convey an indication of incident completion to other IoT nodes, who in turn, may respond as if they themselves determined that the incident has completed. The event propagation instructions generally correspond with block 235.

Medium 330 may also include actuation instructions 336. The actuation instructions may cause device 300 to utilize actuation circuit 360 to actuate the IoT note. Actuation may include activating a circuit (e.g. a door locking circuit) that causes an electrical/electromechanical effect. Actuation may include taking a sensor measurement. Actuation may include a combination of both activating a circuit and taking a measurement. The techniques described herein are not limited to any particular type of actuation. Rather, actuation can include any type of action, be it an output action, a measurement action, or some other action, that may be performed by an IoT node. The actuation instructions generally correspond to blocks 240 and 245.

As mentioned, device 300 may include IoT network interface 340. The IoT network interface may allow the device to connect to an IoT network. As one example, the IoT network interface may be a LoRaWAN wireless network interface that allows the device to connect to a LoRaWAN network. In other cases, the IoT network interface may be a regular network interface (e.g. WiFi, Long Term Evolution (LTE), Bluetooth, etc.) that allows for the device to connect to a network, such as the Internet. What should be understood is that IoT network interface 340 allows the device to send/receive communications from the network (e.g. command center).

Device 300 may also include local event sensing circuit 350. The local even sensing circuit may be any kind of circuit that triggers the device to switch from low to high power mode after determining that the IoT node is part of a currently valid incident. In some cases, the local even sensing circuit may be different than the purpose of the node (e.g. siren sensing circuit on a smart door lock, hose connection circuit on a water pressure detection device). In other cases, the local sensing circuit may also serve the main function of the node (e.g. water pressure sensing circuit may also trigger the device).

Device 300 may include actuation circuit 360. The actuation circuit may be a circuit that allows the device to carry out the function for which it was designed. For example, in the smart door lock case, the actuation circuit may cause the door to lock or unlock. In a water pressure sensing node, the actuation circuit may cause the node to take a water pressure reading. The techniques described herein are not limited to any particular type of actuation circuit. What should be understood is that any type of actuation circuit that allows the node to carry out the function for which it was designed would be suitable.

Device 300 may also include Other node interface 370. As mentioned above, the device may cause its own local event sensing circuit to trigger other, potentially nearby, nodes, such that those nodes behave as if they had been triggered themselves. In some cases, the other node interface may be a wired connection. For example, a set of close by fire hydrants may be wired together such that when a hose is connected to one of them, they all behave as if a hose has been connected. In other cases, other node interface may be a low power wireless interface (e.g. Bluetooth). Although using a wireless interface to communicate with other nodes may utilize power, the amount of power used may be less than if each node remained connected to the IoT network.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a compact disc read only memory (CD-ROM), an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (IC) with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
receiving, at an Internet of Things (IoT) node operating in a low power mode, the IoT node including a local event sensing circuit, an indication of a local event;
sending the indication of the local event to a control center, wherein the control center validates the local event corresponds to an in-progress incident;
receiving an indication from the control center to switch the IoT node to a high power mode when the local event corresponds to an in-progress incident; and
switching to the IoT node to the high power mode, wherein the high power mode allows for real time communications to the IoT node.

2. The method of claim 1 further comprising:
remaining in the low power mode when the local event does not correspond to an in-progress incident.

3. The method of claim 1 further comprising:
receiving an indication that the in-progress incident has completed; and
switching the IoT node to the low power mode.

4. The method of claim 3 wherein the indication that the in-progress incident has completed is received from the local event sensing circuit.

5. The method of claim 3 wherein the indication that the in-progress incident has completed is received from the control center.

6. The method of claim 1 further comprising:
propagating the indication of the local event to other IoT nodes communicatively coupled to the IoT node, wherein the other IoT nodes switch to the high power mode upon receipt of the propagated indication of the local event.

7. The method of claim 1 wherein the low power mode is a Long Range Wide Area Network (LoRaWAN) class A mode and the high power mode is a LoRaWAN class C mode.

8. The method of claim 1 further comprising:
actuating the IoT node using a node actuation circuitry via real time communications to the IoT node.

9. The method of claim 8 further comprising:
actuating the IoT node via a Push-to-Talk (PTT) interface via the real time communications to the IoT node.

10. (canceled)

11. A system comprising:
a processor; and
a memory coupled to the processor, the memory containing thereon a set of instructions that when executed by the processor cause the processor to:
receive, at an Internet of Things (IoT) node operating in a low power mode, the IoT node including a local event sensing circuit, an indication of a local event;
send the indication of the local event to a control center, wherein the control center validates the local event corresponds to an in-progress incident;
receive an indication from the control center to switch the IoT node to a high power mode when the local event corresponds to an in-progress incident; and
switch to the IoT node to the high power mode, wherein the high power mode allows for real time communications to the IoT node.

12. The system of claim 11 further comprising instructions to:
remain in the low power mode when the local event does not correspond to an in-progress incident.

13. The system of claim 11 further comprising instructions to:
receive an indication that the in-progress incident has completed; and
switch the IoT node to the low power mode.

14. The system of claim 11 further comprising instructions to:
propagate the indication of the local event to other IoT nodes communicatively coupled to the IoT node, wherein the other IoT nodes switch to the high power mode upon receipt of the propagated indication.

15. The system of claim 11 further comprising instructions to:
actuate the IoT node using a node actuation circuitry via real time communications to the IoT node.

16. The system of claim 15 further comprising instructions to:
actuate the IoT node via a Push-to-Talk (PTT) interface via the real time communications to the IoT node.

17. A non-transitory processor readable medium containing a set of instructions thereon that when executed by a processor cause the processor to:
receive, at an Internet of Things (IoT) node operating in a low power mode, the IoT node including a local event sensing circuit, an indication of a local event;
send the indication of the local event to a control center, wherein the control center validates the local event corresponds to an in-progress incident;
receive an indication from the control center to switch the IoT node to a high power mode when the local event corresponds to an in-progress incident; and
switch to the IoT node to the high power mode, wherein the high power mode allows for real time communications to the IoT node.

18. The medium of claim 17 further comprising instructions to:
receive an indication that the in-progress incident has completed; and
switch the IoT node to the low power mode.

19. The medium of claim 17 further comprising instructions to:
actuate the IoT node using a node actuation circuitry via real time communications to the IoT node.

20. The medium of claim 17 further comprising instructions to:
actuate the IoT node via a Push-to-Talk (PTT) interface via the real time communications to the IoT node.

21. The method of claim 1 wherein the IoT node is not connected to the network while functioning in low power mode.
